(19) United States
(12) Patent Application Publication
(10) Pub. No.: US 2012/0290467 A1
(43) Pub. Date: Nov. 15, 2012

(54) NETWORKING PLATFORM FOR LENDING

(75) Inventors: Alexander Azariy Shenkar, Roswell, GA (US); Erik Stephen Ross, Charlotte, NC (US); Laura Corinne Bondesen, Charlotte, NC (US)

(73) Assignee: Bank of America Corporation, Charlotte, NC (US)

(21) Appl. No.: 13/269,295

(22) Filed: Oct. 7, 2011

Related U.S. Application Data
(63) Continuation-in-part of application No. 13/103,624, filed on May 9, 2011.

(51) Int. Cl. G06Q 40/02

(52) U.S. Cl. 705/38

(57) ABSTRACT

A networking platform for lending is disclosed. The platform may facilitate communication of potential borrowers and potential lenders where such lenders are not traditional financial institutional lenders. Generally, the platform is configured in a manner in which the loan is facilitated between the borrower and a lender such that the platform service is sufficiently distanced from the actual lending such that the platform provider is not required to comply with various lending statutes and regulations. The platform may additionally be configured to poll a potential borrower's social network to identify acquaintances that may wish to fund at least a portion of the requested loan.

### CROSS-REFERENCE TO RELATED APPLICATIONS

This application is a continuation-in-part application of and claiming priority to U.S. patent application Ser. No. 13/103,624, filed May 9, 2011, entitled “Social Networking Platform for Underwriting,” the entirety of which is incorporated herein by reference.

### BACKGROUND

Oftentimes potential borrowers find it difficult to obtain a loan or obtain credit. For instance, a bad credit history, no credit history, or unfavorable asset-to-debt ratios may make it very difficult for borrowers to obtain funds. Furthermore, major credit lenders tend to be much more cautious with lending presently in light of increasing numbers of defaults due primarily to economic conditions.

Lending funds involves capital management and risk assessment. Risk varies based on a number of factors and conditions. Due to the nature of the business, major credit lenders generally evaluate the risk and approve or disapprove a lending request based on various criteria that indicates whether the risk is acceptable. Thus, if a potential borrower is evaluated as having an elevated risk, most major credit lenders generally have little choice other than to deny the loan application or institute some means to justify the risk such as a higher interest rate, adding or increasing fees, etc.

Furthermore, some borrowers simply have a preference for borrowing through unconventional credit lenders, or in many cases, other individuals. Peer-to-peer lending can provide unique advantages to both borrowers and lenders. For example, lenders willing to accept more risk for a potential higher return may lend to borrowers who are willing to pay the higher rate of return. Prosper Marketplace, Inc. in San Francisco, Calif. provides a web-based means for pseudo peer-to-peer lending. With the Prosper system, borrowers may register and post a loan request. Prosper may restrict access to borrowers who meet minimum credit guidelines. As a result, registering with Prosper as a borrower authorizes Prosper to obtain credit histories. The borrower further authorizes Prosper to display various information which may include a “Prosper rating” which is calculated by Prosper, debt-to-income ratio, whether the borrower owns a home, the number of accounts which are currently late on repayment, the total past due amount on all accounts, and a host of other information. Importantly, all loans through Prosper are made through a Utah-chartered industrial bank (“WebBank”). Investors are allowed to choose the borrowers. Once investors choose the borrowers, WebBank issues the loan and the investor purchases the promissory note.

As Prosper (through WebBank) actually disperses the loan, pulls credit reports, etc., and is licensed as a consumer lending company, Prosper is responsible for being in compliance with all applicable lending regulations such as Fair Credit Reporting Act (FCRA), Unfair or Deceptive Acts or Practices (Regulation AA), Equal Credit Opportunity (Regulation B), Truth in Lending (Regulation Z), Right to Financial Privacy, etc.

To date, borrowers and lenders do not have access to a true peer-to-peer lending platform in which transactions occur directly between individuals or “peers” without the intermediation of a traditional financial institution.

### BRIEF SUMMARY

The following presents a simplified summary of several embodiments of the invention in order to provide a basic understanding of such embodiments. This summary is not an extensive overview of all contemplated embodiments of the invention, and is intended to neither identify key or critical elements of all embodiments, nor delineate the scope of any or all embodiments. Its purpose is to present some concepts of one or more embodiments in a simplified form as a prelude to the more detailed description that is presented later.

Embodiments of the invention address the above needs and/or achieve other advantages by providing apparatuses (e.g., a system, computer program product, and/or other device), methods, or a combination of the foregoing for a social networking platform for lending.

In a first aspect of the invention, a system for providing a networking platform for lending is provided. The system includes a processing device configured for receiving information from a potential borrower relating to a request for a loan. The processing device is further configured for presenting potential borrower loan request information to one or more potential lenders. The potential lenders are not associated with a traditional financial institution. Additionally, the processing device is configured for receiving an indication of an intent to fund at least a portion of the loan from one or more of the potential lenders. The processing device is further configured for facilitating a loan agreement between the potential borrower and the one or more of the potential lenders for the one or more of the potential lenders to fund at least a portion of the loan request.

In some embodiments of the system, the potential borrower is an individual. In some embodiments, at least a portion of the one or more potential lenders are individuals, whereas in other embodiments, each of the potential lenders are individuals.

In some embodiments of the system, the potential borrower was referred to the platform or the potential borrower loan request information was transmitted to the platform with permission to do so from the potential borrower by a traditional financial institution. In some such embodiments, the traditional financial institution declined to fund the potential borrower loan request.

In some embodiments of the system, the facilitating an agreement includes providing a communication link between the potential borrower and the one or more of the potential lenders. In some embodiments, the facilitating a loan agreement includes providing a document containing essential terms of the loan. In some such embodiments, the document is a promissory note.

In some embodiments of the system, the processing device is further configured for polling a social network of the potential borrower to determine acquaintances willing to fund at least a portion of the loan.

In some embodiments of the system, the loan agreement is between the potential borrower and one potential lender. In other embodiments, the loan agreement is between the potential borrower and a plurality of potential lenders. In some such embodiments, each of the plurality of potential lenders fund an equal amount of the loan. In other such embodiments, at least one of the plurality of potential lenders fund an amount of the loan different than the remaining potential lenders.

In some embodiments of the system, the processing device is further configured to transfer funds to the potential borrower pursuant to the loan agreement. In some embodiments, the processing device is further configured to transfer funds from the potential borrower for repayment of the loan. Furthermore, in some embodiments, the processing device is further configured to provide alerts to the potential borrower and/or the one or more potential lenders subject to the loan agreement when a scheduled repayment date is approaching and/or if the potential borrower is delinquent on the loan.

In another aspect of the invention, a method for providing a networking platform for lending is provided. The method includes receiving, via a computing device processor, information from a potential borrower relating to a request for a loan. The method further includes, presenting, via a computing device processor, potential borrower loan request information to one or more potential lenders. The one or more potential lenders are not associated with a traditional financial institution. The method additionally includes receiving an indication of an intent to fund at least a portion of the loan from one or more of the potential lenders. The method further includes facilitating a loan agreement between the potential borrower and the one or more of the potential lenders for the one or more of the potential lenders to fund at least a portion of the loan request.

In some embodiments of the method, the potential borrower is an individual. In some embodiments, at least a portion of the one or more potential lenders are individuals, whereas in other embodiments, each of the potential lenders are individuals.

In some embodiments of the method, the potential borrower was referred to the platform or the potential borrower loan request information was transmitted to the platform with permission to do so from the potential borrower by a traditional financial institution. In some such embodiments, the traditional financial institution declined to fund the potential borrower loan request.

In some embodiments of the method, the facilitating an agreement includes providing a communication link between the potential borrower and the one or more of the potential lenders. In some embodiments, the facilitating a loan agreement includes providing a document containing essential terms of the loan. In some such embodiments, the document is a promissory note.

In some embodiments, the method further includes polling a social network of the potential borrower to determine acquaintances willing to fund at least a portion of the loan.

In some embodiments of the method, the loan agreement is between the potential borrower and one potential lender. In other embodiments, the loan agreement is between the potential borrower and a plurality of potential lenders. In some such embodiments, each of the plurality of potential lenders fund an equal amount of the loan. In other such embodiments, at least one of the plurality of potential lenders fund an amount of the loan different than the remaining potential lenders.

In some embodiments, the method further includes transferring funds to the potential borrower pursuant to the loan agreement. In some embodiments, the method further includes transferring funds from the potential borrower for repayment of the loan. Furthermore, in some embodiments, the method further includes providing alerts to the potential borrower and/or the one or more potential lenders subject to the loan agreement when a scheduled repayment date is approaching and/or if the potential borrower is delinquent on the loan.

In an additional aspect of the invention, a computer program product for providing a networking platform for lending is provided. The computer program product includes a non-transitory computer readable medium including computer-readable instructions. The instructions include instructions for receiving information from a potential borrower relating to a request for a loan. The instructions additionally include instructions for presenting potential borrower loan request information to one or more potential lenders. The one or more potential lenders are not associated with a traditional financial institution. Furthermore, the instructions include instructions for receiving an indication of an intent to fund at least a portion of the loan from one or more of the potential lenders. Additionally, the instructions include instructions for facilitating a loan agreement between the potential borrower and the one or more of the potential lenders for the one or more of the potential lenders to fund at least a portion of the loan request.

In some embodiments of the computer program product, the potential borrower is an individual. In some embodiments, at least a portion of the one or more potential lenders are individuals, whereas in other embodiments, each of the potential lenders are individuals.

In some embodiments of the computer program product, the potential borrower was referred to the platform or the potential borrower loan request information was transmitted to the platform with permission to do so from the potential borrower by a traditional financial institution. In some such embodiments, the traditional financial institution declined to fund the potential borrower loan request.

In some embodiments of the computer program product, the facilitating an agreement includes providing a communication link between the potential borrower and the one or more of the potential lenders. In some embodiments, the facilitating a loan agreement includes providing a document containing essential terms of the loan. In some such embodiments, the document is a promissory note.

In some embodiments, the computer program product further includes instructions for polling a social network of the potential borrower to determine acquaintances willing to fund at least a portion of the loan.

In some embodiments of the computer program product, the loan agreement is between the potential borrower and one potential lender. In other embodiments, the loan agreement is between the potential borrower and a plurality of potential lenders. In some such embodiments, each of the plurality of potential lenders fund an equal amount of the loan. In other such embodiments, at least one of the plurality of potential lenders fund an amount of the loan different than the remaining potential lenders.

In some embodiments, the computer program product further includes instructions for transferring funds to the potential borrower pursuant to the loan agreement. In some embodiments, the computer program product further includes instructions for transferring funds from the potential borrower for repayment of the loan. Furthermore, in some embodiments, the computer program product further includes instructions for providing alerts to the potential borrower and/or the one or more potential lenders subject to the loan agreement when a scheduled repayment date is approaching and/or if the potential borrower is delinquent on the loan.

In another aspect of the present invention, a method for providing a loan is provided. The method includes receiving, at a traditional financial institution, via a computing device processor, a request for a loan from a customer. The method further includes evaluating, via a computing device processor, the financial risk associated with providing the loan to the customer. Additionally, the method includes declining the customer loan request at least in part based on the financial risk evaluation. The method further includes referring the customer to a networking platform for lending. The networking platform comprising a processing device configured for receiving information from the customer relating to a request for the loan. The processing device is further configured for presenting loan request information to one or more potential lenders that are not associated with the traditional financial institution. The processing device is further configured for receiving an indication of an intent to fund at least a portion of the loan from one or more of the potential lenders. Additionally, the processing device is further configured for facilitating a loan agreement between the customer and the one or more of the potential lenders for the one or more of the potential lenders to fund at least a portion of the loan.

In some embodiments of the method, the processing device further comprises polling a social network of the customer to determine acquaintances willing to fund at least a portion of the loan.

The features, functions, and advantages that have been discussed may be achieved independently in various embodiments of the invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 is a block diagram illustrating a loan transaction environment, in accordance with embodiments of the invention;

FIG. 2 is a block diagram illustrating a networking platform for lending in communication with a social network, in accordance with embodiments of the invention;

FIG. 3 is a block diagram illustrating a networking platform for lending in communication with a community, in accordance with embodiments of the invention;

FIG. 4 is a high level flow diagram of a method for providing a financial service, in accordance with an embodiment of the invention; and

FIG. 5 is a high level flow diagram of a method for providing a financial service, in accordance with an embodiment of the invention.

FIG. 6 is a high level flow diagram of a method for providing a financial service, in accordance with an embodiment of the invention.

### DETAILED DESCRIPTION OF EMBODIMENTS OF THE INVENTION

Embodiments of the invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

In accordance with embodiments of the invention, the terms “borrower,” “customer,” and “user” are used interchangeably and refer to a customer seeking a loan.

In accordance with embodiments of the invention, the term “acquaintance” or “acquaintances” refers to a party that the borrower is connected to via a social network. The acquaintance may be a friend, family member, indirect friend (i.e. “friend of a friend”), etc. so long as the acquaintance has at least some type (no matter how minor) of connection to the borrower.

In accordance with embodiments of the invention, a “social network” is a social structure made up of individuals (or organizations) which are connected by one or more specific types of interdependency, such as friendship, kinship, common interest, financial exchange, dislike, relationships, beliefs, knowledge, prestige, etc. The social network may be web-based social structure or a non-web-based social structure. In some embodiments, the social network may be inferred from financial transaction behavior, mobile device behaviors, etc. The social network may be a network unique to the invention or may incorporate already-existing social networks such as Facebook®, Twitter®, Linkedin®, YouTube® as well as a plethora of web logs or “blogs,” forums and other social spaces.

In accordance with embodiments of the invention, the terms “risk” or “financial risk” refers to the risk of a borrower defaulting on a loan.

In accordance with embodiments of the invention, the term “financial institution” refers to any organization in the business of moving, investing, or lending money, dealing in financial instruments, or providing financial services. This includes commercial banks, thrifts, federal and state savings banks, savings and loan associations, credit unions, investment companies, merchants, insurance companies and the like.

In general, embodiments of the invention relate to apparatuses, methods and computer program products for a networking platform for lending. Numerous users in need of a loan find themselves being denied by traditional financial institutions. In some instances, denials are a result of being evaluated as an elevated risk for financial loss by the financial service provider. Unfortunately, most service providers are incapable of taking into account the “intangibles” associated with a user because there is no personal connection with the user in most situations. Oftentimes, users have very few avenues from which to obtain a needed loan which causes such users financial and/or emotional hardship.

In recognition of the above, generally, the invention provides a networking platform for peer-to-peer lending. The platform may bring together potential borrowers and potential lenders where such lenders may be open to lending to elevated risk borrowers. Generally, the platform is configured in a manner in which the loan is facilitated between the borrower and a lender that is not a traditional financial institution. As such, the provider of the platform is sufficiently distanced from the lending such that the provider is not required to comply with numerous and often stringent lending statutes and regulations.

Additionally, social network acquaintances may be contacted or otherwise polled to determine their agreeability with serving as a lender for the user's desired loan request. In some instances a plurality of acquaintances or other lenders may be utilized to fulfill a borrower's loan request to substantially disperse the financial risk among numerous lenders.

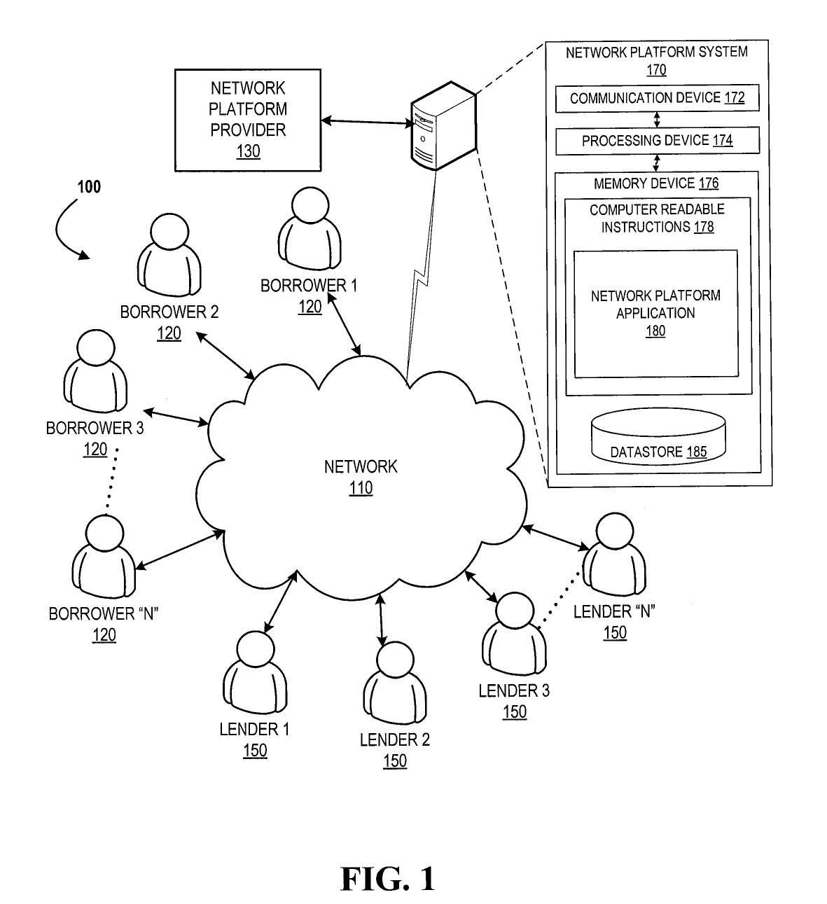

Referring to FIG. 1, a block diagram illustrates a loan transaction environment 100 configured for transacting across a network 110 according to embodiments of the invention. As illustrated, the loan transaction environment 100 includes one or more borrowers 120 (i.e., the customer/borrower) who wishes to obtain a loan from one or more lenders 150 network 110 connecting a borrower 120 and at least one lender 150.

In FIG. 1, the network 110 may include a local area network (LAN), a wide area network (WAN), and/or a global area network (GAN). The network 110 may provide for wireline, wireless, or a combination of wireline and wireless communication between communication devices in the network. The network 110, in some embodiments, includes the Internet.

The network platform provider 130 may be any person or entity capable of administering the platform. In some embodiments, the network platform provider 130 is a financial institution or affiliated with a financial institution. A financial institution may have access to potential borrowers and lenders that would have an interest in a peer-to-peer platform as described herein. For example, in some embodiments, a financial institution may opt to decline a loan request from a customer due to a determined heightened risk of default. However, the financial institution may suggest alternative options, such as the platform, where the customer may connect with one or more lenders that are not traditional financial institutions that may be willing to fund the customer's loan request.

As illustrated in FIG. 1, the loan transaction environment 100 may include any number of lenders 150. While “N” number of lenders 150 is illustrated, it should be noted that “N” may be any whole number. In some embodiments, the lenders 150 comprise acquaintances associated with a particular borrower via a social network. Similarly, “N” number of borrowers 120 is illustrated wherein “N” may be any whole number of borrowers present within the network 110.

In terms of minimizing the average risk per lender, it may be preferable to have numerous lenders 150 agree to specific amounts or percentages of a loan request of a particular borrower 120 to minimize the risk of substantial loss to any one lender 150. For example, if a borrower 120 defaults on a $10,000 loan and there are ten lenders 150, the lenders 150 are responsible for an average of $1,000 each. In contrast, if the $10,000 loan has one hundred lenders 150, then the average risk of total loss of each lender 150 is only $100.

The above example utilizes the “average” amount for each lender 150 because it is not necessary that each lender 150 fund the same amount or percentage of the total loan. In one embodiment, the lenders 150 may select the maximum amount of funding for a particular borrower 120 loan request. For instance, the a first lender 150 may opt to “bid” a maximum of $1,000 (or 10%) for a borrower's $10,000 loan request whereas another lender 150 may only wish to “bid” a maximum of $100 (or 1%) for the borrower's $10,000 loan.

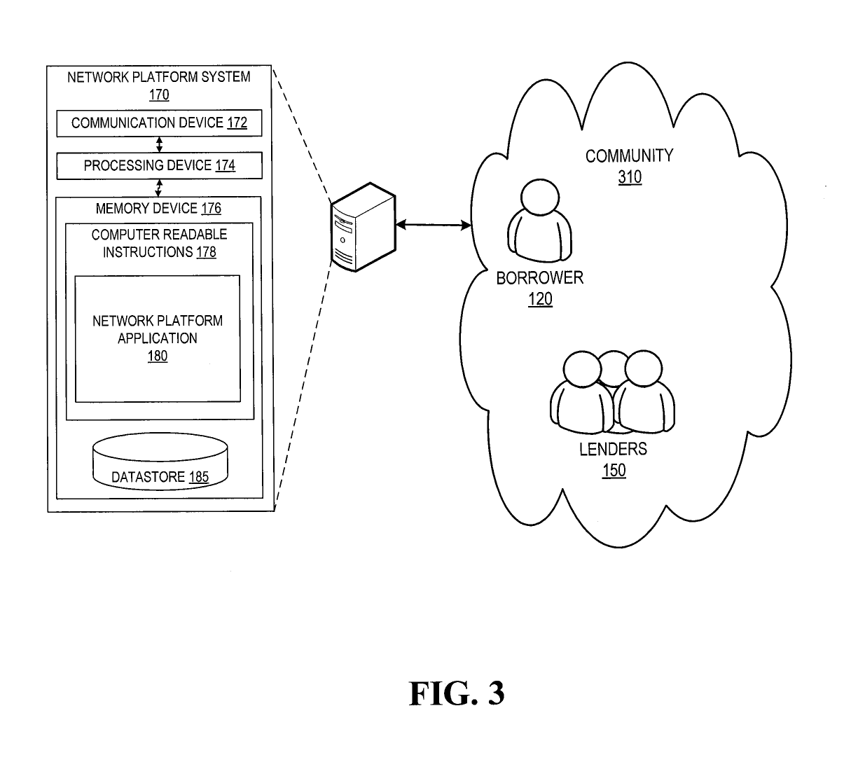

In addition, as illustrated, a network platform system 170 is generally present within the lending transaction environment 100. The network platform system 170 may, in various embodiments be configured for performing one or more of the steps and/or sub-steps discussed with reference to FIGS. 3-5 below and/or one or more additional steps and/or sub-steps. In the configuration shown, the network platform system 170 communicates across the network 110 with one or more remote devices, such as workstation (not shown) that may be operated by one or more of the lenders 150, the borrowers 120, or the network platform provider 130. The borrowers 120, lenders 150, or network platform provider 130 can interact with the network platform system 170 using a variety of devices remote to the network platform system 170. Furthermore, in some embodiments one or more entities can interact with the network platform system 170 locally such as through an input/output device attached directly with the network platform system 170.

FIG. 1 illustrates a single network platform provider 130 in communication with the network platform system 170. It will be understood, however, that any number of borrowers 120, lenders 150, and network platform providers 130 may be present within the network 110. However, in a particular embodiment, one network platform provider 130 provides the infrastructure platform and service of the network platform system 170.

In some embodiments, the borrowers 120, lenders 150, network platform provider 130, or any other individual or entity within the network 110, may communicate with the network 110 via a mobile device. A “mobile device” may be any mobile communication device, such as a cellular telecommunications device (i.e., a cell phone or mobile phone), personal digital assistant (PDA), a mobile Internet accessing device, or other mobile device including, but not limited to portable digital assistants (PDAs), pagers, mobile televisions, gaming devices, laptop computers, cameras, video recorders, audio/video player, radio, GPS devices, any combination of the aforementioned, or the like.

The network platform system 170, in various embodiments, has a communication device 172 controlled by a processing device 174 in order to communicate across the network 110. As noted above, the network 110 is an intranet, the Internet, a local area network, a wide area network, and/or any other electronic device network, and/or any combination of the same. The processing device 174 is also in communication with a memory device 176 configured for storing computer-readable and computer-executable instructions 178. The computer-readable instructions, in various embodiments, include one or more applications, such as a social network platform application 180.

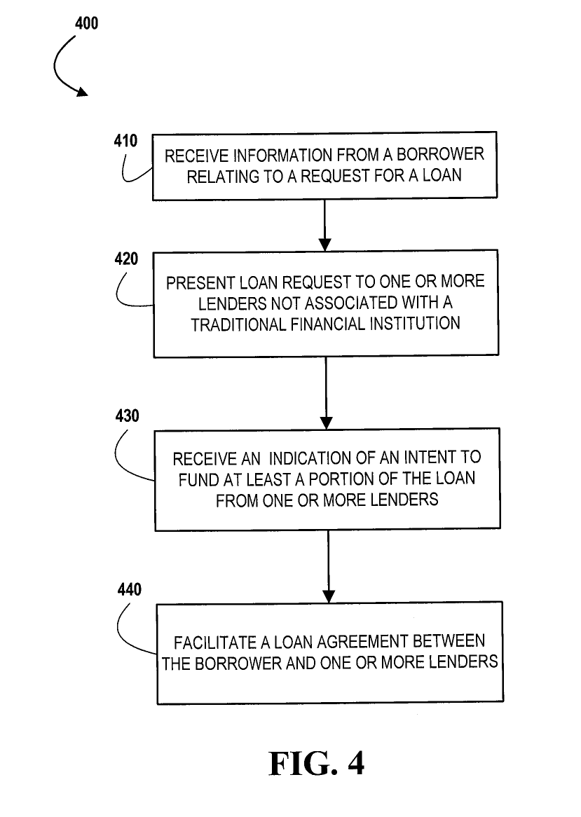

Generally, in some embodiments, some, all or none of the method steps and/or sub-steps discussed below with reference to FIGS. 3, 4 and/or 5 are embodied in computer-executable instructions within the network platform application 180. In some embodiments, one or more applications are contained within a single network platform application 180, and in other embodiments, the instructions for executing the method steps disclosed herein are spread over two or more applications. In some embodiments, some of the instructions for executing the methods disclosed herein are stored on the network platform system 170 and some of the instructions are stored on a user device. In some embodiments, some or all the instructions are stored remotely from the network platform system 170 and accessed as necessary by the network platform system 170 and/or any other device requiring instructions. Further, in some embodiments, the memory device 176 includes a datastore 185 or database configured for storing information and/or data. In other embodiments, the datastore 185 is housed remotely from the network platform system 170 and the network platform system 170 is in communication with the datastore 185 across the network 110 and/or across some other communication link.

In some embodiments one or more additional systems or servers are configured for communicating with the network platform system 170. In some such embodiments, information regarding different borrowers 120 and/or lenders 150 may be stored in various locations on different systems. In some embodiments, information regarding borrowers 120 and/or lenders 150 financial accounts, social networks, funds sharing networks and the like may be stored on separate systems or datastores. In some embodiments, a network platform system 170 functions as a central control server and accesses the various pieces of customer information from various locations. In various other embodiments, multiple servers or systems functions together as a central control server and access different pieces of data and/or instructions in order to perform one or more of the method steps discussed herein.

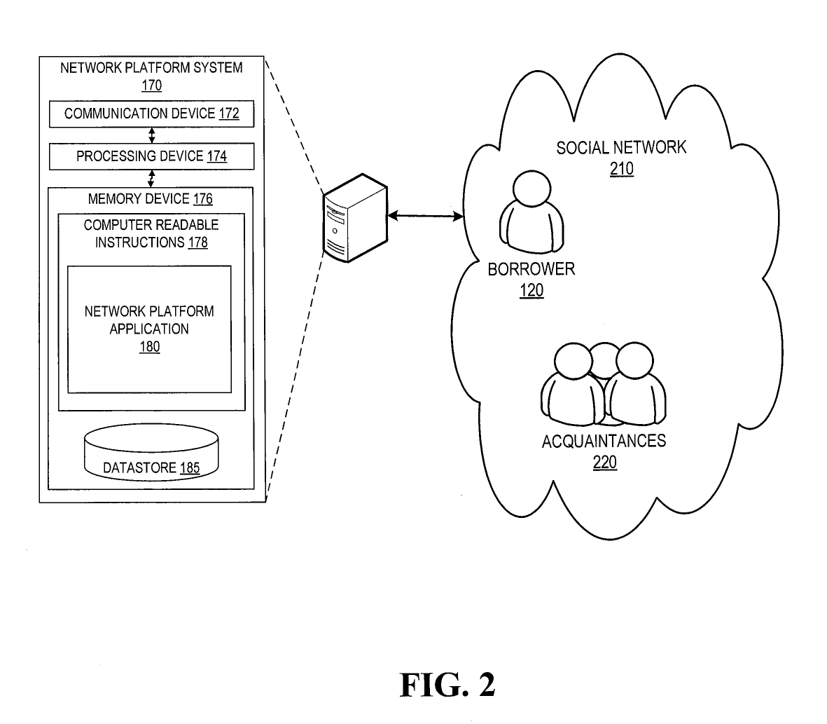

Referring now to FIG. 2, a block diagram illustrates a network platform system 170 in communication with a borrower 120 social network 210 according to embodiments of the invention. The borrower's social network 210 may include a plurality of acquaintances 220. While a single social network 210 is illustrated, it will be appreciated that the networking platform system 170 may be in communication with a plurality of different social networks that the borrower belongs to. Additionally, while FIG. 2 illustrates the social network 210 as being associated with a borrower 120, it will be understood that the network platform system 170 may be in communication with a social network 210 of a lender 150 as well. Indeed, in some embodiments it will be beneficial for a lender 150 to have the option of searching his social network 210 for one or more borrowers 120 with loan requests.

The process for reaching an agreement between one or more borrowers 120 and one or more lenders 150 may proceed by any means that properly brings the parties together in an agreement. For instance, in one embodiment, the network platform system 170, with the borrower's consent, may poll some or all of the acquaintances 220 within the borrower's social network to determine how much (if any) the acquaintances 220 are willing to fund. In another embodiment, a borrower 120 may generally make it known the type of loan he desires. The lenders 150 may then make competing offers and the borrower 120 may select the most favorable offer. Whatever the means in which the borrowers 120 and lenders 150 utilize to reach an agreement, the network platform provider 130 remains sufficiently withdrawn from the lending process such that the provider 130 is not responsible for complying with various lending regulations such as Fair Credit Reporting Act (FCRA), Unfair or Deceptive Acts or Practices (Regulation AA), Equal Credit Opportunity (Regulation B), Truth in Lending (Regulation Z), Right to Financial Privacy, etc. As such, generally, the provider 130 does not pull borrower credit history reports (for services explicitly related to the platform 170), lend any funds, or act as a lender 150 in any capacity. However, it is contemplated that the provider 130 may assist a borrower 120 or a lender 150 in providing information to or obtaining information from the other parties to the loan agreement. It is contemplated that the platform provider 130 may utilize any means to facilitate an agreement between the parties, as long as such means does not arise to the level necessary to trigger various regulatory requirements discussed above.

Similarly, as illustrated in FIG. 3, in one embodiment, the one or more borrowers 120 may receive funding from lenders 150 within their community 310, i.e. locally. Local vesting, also termed “locavesting,” may provide unique benefits to both borrowers 120 and lenders 150. Lenders 150 may be more willing to lend funds if the funds are going to be utilized within their community. Additionally, lenders 150 may be more willing to take a financial risk if it is for the betterment of their community.

Thus, “locavesting” utilizing the network platform system 170 may help keep funding within a community and provide economic stimulus to the borrower's/lender's community 310. For example, such an embodiment may be useful for a borrower 120 that is a small business or a start-up that may not be an attractive investment opportunity to potential lenders 150 that are not within the community 310.

Furthermore, a borrower 120 that receives funds from local lenders 150 may feel more social pressure to repay the loan. Indeed, in contrast to loans funded by a major credit lender, loans made between parties personally known to each other or between parties within a community create a certain dynamic with associated advantages. One advantage of personal lending is that the borrower 120 often feels a personal obligation to repay the lender, in addition to the contractual obligation. Theoretically, this dynamic should substantially lower the risk of default by taking advantage of sociological and psychological principles such as social norms and reciprocity.

Social norms define the behaviors within a group (such as a social network), i.e., the appropriate and inappropriate values, beliefs, attitudes and behaviors. Ignoring social norms risks one becoming unacceptable, unpopular, or even an outcast from the group or community. Similarly, reciprocity refers to the psychological tendency to respond to a positive action with another positive action. Reciprocal actions are important to social psychology as they can help explain the maintenance of social norms. If a sufficient proportion of the group interprets the breaking of a social norm (e.g., defaulting on a personal loan) by another as a hostile action and if the group is willing to take action to punish the rule-breaker, then this can maintain the norm in the absence of formal sanctions. Punishing action may range from negative words to complete social ostracism.

FIG. 4 illustrates a high level flow diagram of a method 400 for peer-to-peer lending. At block 410, information is received from a borrower 120 relating to a request for a loan. The information may include a desired loan amount, interest rate, repayment term, lender preferences, etc.

At block 420, one or more lenders 150 not associated with a traditional financial institution are presented or otherwise view the borrower's loan request. The lenders 150 may have access to the specifics of the borrower's loan request as well as additional information such as the borrower's credit account information, credit history, assets-to-debt ratios, age, income, etc. that may be provided by the borrower 120. The borrower's identity may or may not be known to the lenders 150. For instance, the borrower's identity may stay hidden at the request of the borrower 120 and only revealed upon the instance of a default or pending default on the loan.

After reviewing the borrower's loan request information, the lenders 150 may evaluate the request and choose to fund the loan. As represented at block 430, one or more lenders may give an indication of intent to fund at least a portion of the loan. A lender 150 may opt to fund all or only a portion of the loan request. Furthermore, as discussed above, a lender 150 may opt to fund a certain amount and spread the amount over numerous borrower 120 loans in order to diversify and limit the overall risk. The platform 170 may assist the lender 150 in diversifying by providing package options, options to choose the number of borrowers 120 to spread the total amount funded over, etc. The platform 170 may be configured to incentivize lenders 150 for taking more risk (e.g., funding all of a single loan request) versus diversifying and funding small amounts of numerous loan requests. For instance, the platform may provide a larger return on investment to the lender for a higher risk loan by, for instance, providing a reduction in platform fees. Alternatively, the platform may be configured such that all lender 150 funds are deposited into one or more pools of funds and each lender 150 within the fund pool receives approximately the same rate of return based upon percentage of repayment from the borrowers 120 (i.e., a higher return for less borrowers that defaults that the pool funds).

At block 440, the platform 170 acts to facilitate a loan agreement between the borrowers 120 and the lenders 150. Again, as noted above, the platform 170 may utilize any means to facilitate a loan agreement as long as various regulatory requirements are not triggered on behalf of the provider 130. For example, the platform 170 may generate a form agreement containing the necessary terms for the borrowers 120 and lenders 150.

The platform 170 may additionally be configured to monitor the status of loan repayment and send reminders, alerts, etc. to borrowers 120 and/or lenders 150 reporting the status of repayment. In the event of a default, the platform 170 may alert the lenders 150 that the borrower 120 has defaulted. In one embodiment, the platform 170 is further configured to assist the lenders 150 with handling post-default procedures including, but not limited to, referring the lenders 150 to a collection service or attorney to assist in default proceedings, providing standard forms for initiating a default proceeding, etc.

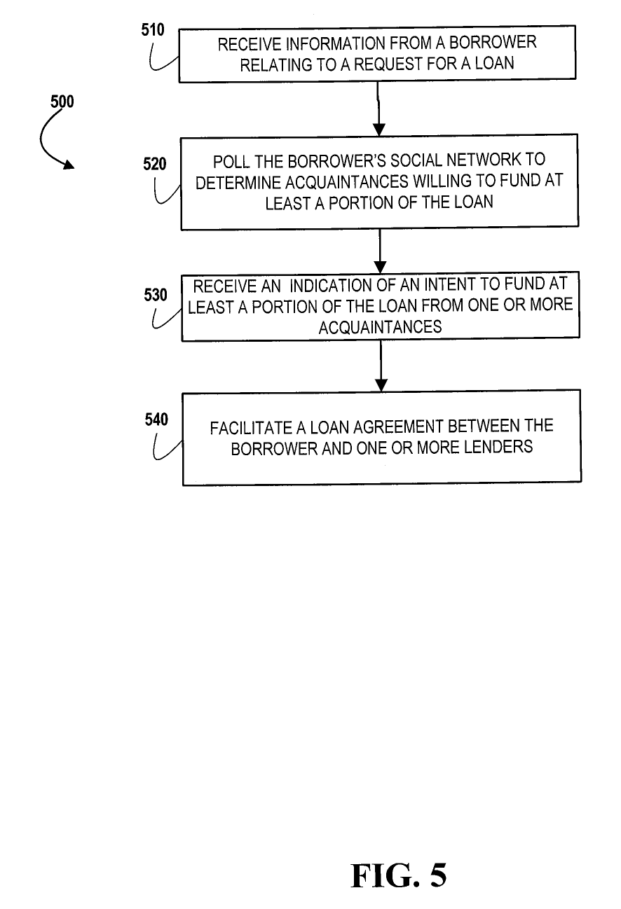

FIG. 5 illustrates a high level flow diagram of a method 500 for peer-to-peer lending. At block 510, information is received from a borrower 120 relating to a loan request. Again, as noted above, any information may be provided by the borrower 120 or on the borrower's behalf at the request of the borrower 120. In a particular embodiment, the provider 130 may be a financial institution that rejected a similar loan request from the borrower 120 and, with the borrower's permission, submitted the loan request to lenders 150 within the network platform system 170.

In the embodiment illustrated, the platform 170 may act to poll one or more social networks 210 in which the borrower 120 belongs, as illustrated at block 520 to determine if any acquaintances 220 are willing to fund at least a portion of the loan request. The polling may be accomplished by any means that results in obtaining the desired information. In one embodiment, the platform 170 may send a private message to all or just selected members of the borrower's social network 210 and explain the requested loan and terms of the potential agreement. The acquaintances 220 may respond with the amount or percentage they wish to fund and the desired terms of the agreement. In an alternative embodiment, the borrower 120 may simply post publicly on the social network 210 the loan desired and acquaintances 220 may respond with how much they are willing to fund.

At block 530, one or more acquaintances 220 may give an indication of intent to fund at least a portion of the loan. Each acquaintance 220 may opt to fund all or only a portion of the loan request. Additionally, it will be appreciated that the total number of lenders 150 that are utilized to fund the loan may include acquaintances 220 within the borrower's social network 210 as well as lenders 150 that are not additionally associated with the borrower 150 via the social network 210.

At block 540, the platform 170 acts to facilitate a loan agreement between the borrowers 120 and the lenders 150 as similarly described with respect to FIG. 3.

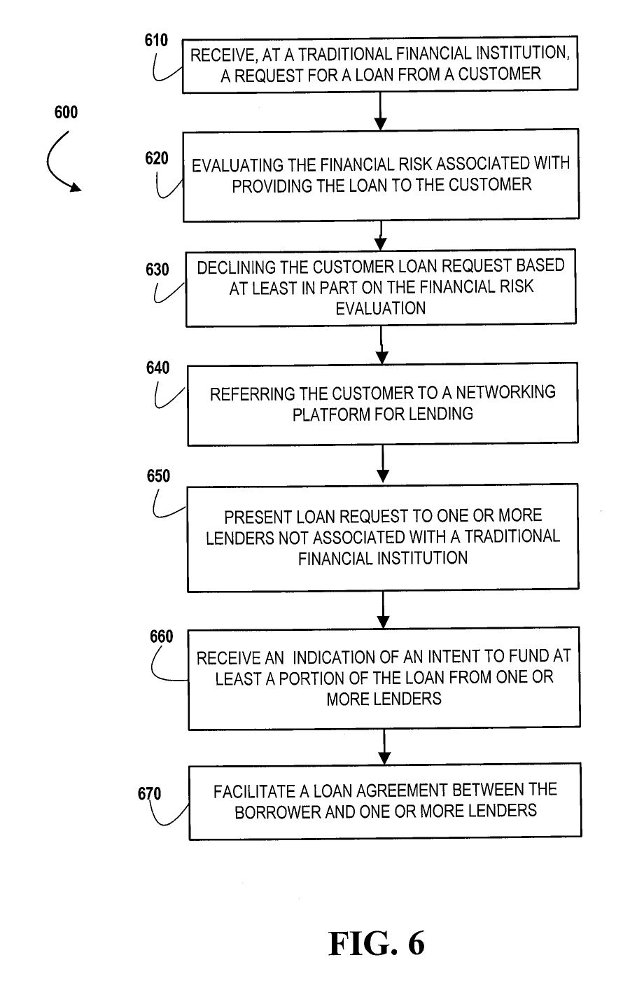

Turning now to FIG. 6, illustrated is a high level flow diagram of a method 600 for providing a loan. At block 610, a traditional financial institution, which, in this embodiment, may also be the provider 130 of the network platform system 170, receives a request for a loan from a customer. The loan request may be made by any means conventional with traditional financial institutions.

At block 620, the financial institution evaluates the financial risk associated with providing the loan to the customer. At this point in the process, the financial institution is considering loaning the customer the requested funds and, as such, acts as a potential lender 150. As such, the financial institution may utilize the conventional means in evaluating the risk associated with the requested loan. Thus, at this stage, the financial institution may be subject to the regulatory lending requirements discussed above. However, if the loan request is declined and the customer referred or transferred to the platform 170, the financial institution's regulatory requirements cease as the institution has formally declined to fulfill the loan request and merely facilitate communication and agreement with potential peer lenders via the network platform system 170.

As the process moves to block 630, the customer loan request is declined by the financial institution based at least in part on the financial risk evaluation. As discussed above, the financial institution, as provider 130 of the platform 170 refers or transfers the customer's loan request to the platform 170 such that the customer may seek funding from peers, as illustrated at block 640. Of note, if the platform 170 is healthy and established such that a large number of lenders 150 are present within the system, the ability of the financial institution to provide such a platform service may be extremely beneficial as the financial institution could market extraordinarily high percentages of loan requests being approved or otherwise facilitated by the financial institution. Such marketing could provide a substantial increase in customer base, especially in times of an economic recession.

At block 650, the loan request may be presented to lenders 150 associated with the platform 170. Similar to FIG. 5 above, one or more of the lenders 150 may be polled from the customer's social network 210 in order to determine if any acquaintances 220 wish to fund at least a portion of the loan request.

As the process moves to block 660, one or more lenders 150 may provide indication of intent to fund at least a portion of the loan request. The process then concludes at block 670 wherein the platform 170 may be configured to facilitate a loan agreement between the customer and lenders 150 similar to that discussed above.

Importantly, the platform 170 may be utilized in conjunction with incentives or hybrid-type loans. For instance, in one embodiment, a lender 150 may incentivize a borrower 120 to achieve certain goals. The incentives may include a reduction in the interest rate, an increase in funds, forgiveness of at least a portion of the loan, waiver of fees, etc. Indeed, in one embodiment, as the borrower 120 achieves certain repayment goals, the lenders 150 may increase funding. The goals to be achieved could encompass anything the lenders 150 wish to advocate. The goals can include simply repayment goals or may include goals that may advance an agenda of the lender 150, such as employment of a certain number of employees, or employees within a certain community, charitable contributions, environmental considerations, etc.

Additionally, in one embodiment, the platform 170 may be utilized as essentially a “credit line” for one or more borrowers 120. In such an embodiment, one or more lenders 150 may pool funds to be available to be accessed by the borrower 120. The borrower 120 may be required to pay a fee for the credit line and at least a portion of the fee funding at least a portion of the return on the lender's investment.

In some embodiments, the platform 170 may be utilized to fund a portion of the loan to the borrower 120. For example, a financial institution may agree to fund some of the requested loan and the platform 170 utilized to fund the remainder of the loan.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the invention, however, the computer-readable medium may be transitory, such as, for example, a propagation signal including computer-executable program code portions embodied therein.

One or more computer-executable program code portions for carrying out operations of the invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the invention are written in conventional procedural programming languages, such as the “C” programming languages and/or similar programming languages. The computer program code may alternatively or additionally be written in one or more multi-paradigm programming languages, such as, for example, F#.

Some embodiments of the invention are described herein above with reference to flowchart illustrations and/or block diagrams of apparatuses and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the invention.

As used herein, a processor/computer, which may include one or more processors/computers, may be “configured to” perform a stated function in a variety of ways, including, for example, by having one or more general-purpose circuits perform the stated function by executing one or more computer-executable program code portions embodied in a computer-readable medium, and/or by having one or more application-specific circuits perform the stated function.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for providing a networking platform for lending comprising:
a processing device configured for:
receiving information from a potential borrower relating to a request for a loan;
presenting potential borrower loan request information to one or more potential lenders, wherein the one or more potential lenders are not associated with a traditional financial institution;
receiving an indication of an intent to fund at least a portion of the loan from one or more of the potential lenders; and
facilitating a loan agreement between the potential borrower and the one or more of the potential lenders for the one or more of the potential lenders to fund at least a portion of the loan request.

2. The system of claim 1, wherein the potential borrower is an individual.

3. The system of claim 1, wherein at least a portion of the one or more potential lenders are individuals.

4. The system of claim 3, wherein each of the one or more potential lenders are individuals.

5. The system of claim 1, wherein the potential borrower was referred to the platform or the potential borrower loan request information was transmitted to the platform with permission to do so from the potential borrower by a traditional financial institution.

6. The system of claim 5, wherein the traditional financial institution declined to fund the potential borrower loan request.

7. The system of claim 1, wherein the facilitating an agreement comprises providing a communication link between the potential borrower and the one or more of the potential lenders.

8. The system of claim 1, wherein the facilitating a loan agreement comprises providing a document containing essential terms of the loan.

9. The system of claim 8, wherein the document is a promissory note.

10. The system of claim 1, wherein the processing device is further configured for polling a social network of the potential borrower to determine acquaintances willing to fund at least a portion of the loan.

11. The system of claim 1, wherein the loan agreement is between the potential borrower and one potential lender.

12. The system of claim 1, wherein the loan agreement is between the potential borrower and a plurality of potential lenders.

13. The system of claim 12, wherein each of the plurality of potential lenders fund an equal amount of the loan.

14. The system of claim 12, wherein at least one of the plurality of potential lenders fund an amount of the loan different than the remaining potential lenders.

15. The system of claim 1, wherein the processing device is further configured to transfer funds to the potential borrower pursuant to the loan agreement.

16. The system of claim 1, wherein the processing device is further configured to transfer funds from the potential borrower for repayment of the loan.

17. The system of claim 1, wherein the processing device is further configured to provide alerts to the potential borrower and/or the one or more potential lenders subject to the loan agreement when a scheduled repayment date is approaching and/or if the potential borrower is delinquent on the loan.

18. A method for peer-to-peer lending via a networking platform comprising:
receiving, via a computing device processor, information from a potential borrower relating to a request for a loan;
presenting, via a computing device processor, potential borrower loan request information to one or more potential lenders, wherein the one or more potential lenders are not associated with a traditional financial institution;
receiving an indication of an intent to fund at least a portion of the loan from one or more of the potential lenders; and
facilitating a loan agreement between the potential borrower and the one or more of the potential lenders for the one or more of the potential lenders to fund at least a portion of the loan request.

19. The method of claim 18, wherein the potential borrower is an individual.

20. The method of claim 18, wherein at least a portion of the one or more potential lenders are individuals.

21. The method of claim 20, wherein each of the one or more potential lenders are individuals.

22. The method of claim 18, wherein the potential borrower was referred to the platform or the potential borrower loan request information was transmitted to the platform with permission to do so from the potential borrower by a traditional financial institution.

23. The method of claim 22, wherein the traditional financial institution declined to fund the potential borrower loan request.

24. The method of claim 18, wherein the facilitating an agreement comprises providing a communication link between the potential borrower and the one or more of the potential lenders.

25. The method of claim 18, wherein the facilitating a loan agreement comprises providing a document containing essential terms of the loan.

26. The method of claim 25, wherein the document is a promissory note.

27. The method of claim 18, further comprising polling a social network of the potential borrower to determine acquaintances willing to fund at least a portion of the loan.

28. The method of claim 18, wherein the loan agreement is between the potential borrower and one potential lender.

29. The method of claim 18, wherein the loan agreement is between the potential borrower and a plurality of potential lenders.

30. The method of claim 29, wherein each of the plurality of potential lenders fund an equal amount of the loan.

31. The method of claim 29, wherein at least one of the plurality of potential lenders fund an amount of the loan different than the remaining potential lenders.

32. The method of claim 18, further comprising transferring funds to the potential borrower pursuant to the loan agreement.

33. The method of claim 18, further comprising transferring funds from the potential borrower for repayment of the loan.

34. The method of claim 18, further comprising providing alerts to the potential borrower and/or the one or more potential lenders subject to the loan agreement when a scheduled repayment date is approaching and/or if the potential borrower is delinquent on the loan.

35. A computer program product for peer-to-peer lending via a networking platform, the computer program product comprising a non-transitory computer readable medium comprising computer-readable instructions, the instructions comprising:
instructions for receiving information from a potential borrower relating to a request for a loan;
instructions for presenting potential borrower loan request information to one or more potential lenders, wherein the one or more potential lenders are not associated with a traditional financial institution;
instructions for receiving an indication of an intent to fund at least a portion of the loan from one or more of the potential lenders; and
instructions for facilitating a loan agreement between the potential borrower and the one or more of the potential lenders for the one or more of the potential lenders to fund at least a portion of the loan request.

36. The computer program product of claim 35, wherein the potential borrower is an individual.

37. The computer program product of claim 35, wherein at least a portion of the one or more potential lenders are individuals.

38. The computer program product of claim 37, wherein each of the one or more potential lenders are individuals.

39. The computer program product of claim 35, wherein the potential borrower was referred to the platform or the potential borrower loan request information was transmitted to the platform with permission to do so from the potential borrower by a traditional financial institution.

40. The computer program product of claim 39, wherein the traditional financial institution declined to fund the potential borrower loan request.

41. The computer program product of claim 35, wherein the facilitating an agreement comprises providing a communication link between the potential borrower and the one or more of the potential lenders.

42. The computer program product of claim 35, wherein the facilitating a loan agreement comprises providing a document containing essential terms of the loan.

43. The computer program product of claim 42, wherein the document is a promissory note.

44. The computer program product of claim 35, wherein the instructions further comprise instructions for polling a social network of the potential borrower to determine acquaintances willing to fund at least a portion of the loan.

45. The computer program product of claim 35, wherein the loan agreement is between the potential borrower and one potential lender.

46. The computer program product of claim 35, wherein the loan agreement is between the potential borrower and a plurality of potential lenders.

47. The computer program product of claim 46, wherein each of the plurality of potential lenders fund an equal amount of the loan.

48. The computer program product of claim 46, wherein at least one of the plurality of potential lenders fund an amount of the loan different than the remaining potential lenders.

49. The computer program product of claim 35, wherein the instructions further comprise instructions for transferring funds to the potential borrower pursuant to the loan agreement.

50. The computer program product of claim 35, wherein the instructions further comprise instructions for transferring funds from the potential borrower for repayment of the loan.

51. The computer program product of claim 35, wherein the instructions further comprise instructions for providing alerts to the potential borrower and/or the one or more potential lenders subject to the loan agreement when a scheduled repayment date is approaching and/or if the potential borrower is delinquent on the loan.

52. A method for providing a loan, the method comprising:
receiving, at a traditional financial institution, via a computing device processor, a request for a loan from a customer;
evaluating, via a computing device processor, the financial risk associated with providing the loan to the customer;
declining the customer loan request at least in part based on the financial risk evaluation;
referring the customer to a networking platform for lending, the networking platform comprising a processing device configured for
receiving information from the customer relating to a request for the loan;
presenting loan request information to one or more potential lenders, wherein the one or more potential lenders are not associated with the traditional financial institution;
receiving an indication of an intent to fund at least a portion of the loan from one or more of the potential lenders; and
facilitating a loan agreement between the customer and the one or more of the potential lenders for the one or more of the potential lenders to fund at least a portion of the loan.

53. The method of claim 52, wherein the processing device further comprises polling a social network of the customer to determine acquaintances willing to fund at least a portion of the loan.
